(19) United States
(12) Patent Application Publication
(10) Pub. No.: US 2007/0146501 A1
(43) Pub. Date: Jun. 28, 2007

(54) Image pickup apparatus

(75) Inventor: Kenji Matsuoka, Kanagawa-ken (JP)

Correspondence Address: NATH & ASSOCIATES PLLC, 112 South West Street, Alexandria, VA, 22314, US

(73) Assignee: VICTOR COMPANY OF JAPAN, LIMITED, Yokohama-shi (JP)

(21) Appl. No.: 11/643,856

(22) Filed: Dec. 22, 2006

(30) Foreign Application Priority Data
Dec. 26, 2005 (JP) P2005-372585

(51) Int. Cl. H04N 9/73

(52) U.S. Cl. 348/226.1

(57) ABSTRACT

An image pickup apparatus has a CMOS image pickup device. An image pickup area of the image pickup device includes a regular image pickup area and an environment detection area. A flicker detector of the image pickup apparatus detects a frequency component in an image signal provided by the environment detection area. Based on the detected frequency component, a system controller of the image pickup apparatus determines whether or not the image pickup apparatus is in a flicker causing environment. If it is in the flicker causing environment, a timing generator of the image pickup apparatus sets an exposure time for the regular image pickup area so as to suppress flicker. At this time, no change is made in an exposure time for the environment detection area, so that a flicker causing environment may continuously be detectable.

### BACKGROUND OF THE INVENTION

1. Field of the Invention

The present invention relates to an image pickup apparatus employing an x-y addressing image pickup device such as a CMOS (complementary metal oxide semiconductor) image pickup device.

2. Description of Related Art

An image pickup apparatus such as a video camera causes flicker when photographing an image under an AC light such as a fluorescent light energized by an AC power source depending on a relationship between the vertical synchronization frequency and exposure time of the image pickup apparatus and the ON/OFF frequency (double the frequency of the AC power source) of the fluorescent light.

If the image pickup apparatus employs an x-y addressing image pickup device such as a CMOS image pickup device, each pixel of the image pickup device may have a different exposure time. Exposure time differences in a line direction greatly affect the quality of picked-up images and sometimes cause not only flicker but also lateral stripes.

FIG. 1 shows image pickup areas of an x-y addressing image pickup device such as a CMOS image pickup device. The area A is a regular image pickup area that is generally used to pick up images and is surrounded by the area B serving as a camera shake compensation area.

FIG. 2 is a timing chart showing the exposure timing of the image pickup device of FIG. 1. In this example, the image pickup device is an NTSC device and operates at a vertical synchronization frequency of 60 Hz and an exposure time t₁ of 1/60 seconds under a non-inverter fluorescent light energized by a power source frequency of 50 Hz. In FIG. 2, a vertical synchronization signal has a period S₁ of 1/60 seconds, and the fluorescent light has a brightness change period S₂ of 1/100 seconds. In each of lines L₁, L₂, . . . in the areas A and B, the exposure time t₁ is 1/60 seconds.

As shown in FIG. 2, the x-y addressing image pickup device has different exposure timing line by line. More precisely, each pixel in the same line has different exposure timing. The timing difference in the same line is very small relative to the brightness change of the fluorescent light, and therefore, causes no conspicuous flicker. Accordingly, it is practical to neglect the exposure timing difference of each pixel in the same line and consider only exposure timing differences in a vertical direction.

In FIG. 2, the fluorescent light turns on and off five times in every three fields with the vertical synchronization frequency of 60 Hz and power source frequency of 50 Hz. As mentioned above, the x-y addressing image pickup device differs exposure timing line by line. As a result, if a photographed object provides a uniform signal, each field of the photographed image involves lateral stripes shown in FIGS. 3A to 3C due to the brightness change of the fluorescent light. Between adjacent ones of the consecutive fields F₁, F₂, F₃, . . . , the vertical synchronization signal period and the brightness change period of the fluorescent light show a difference that repeatedly appears every three fields.

FIG. 4 is a timing chart showing the exposure timing of the image pickup device of FIG. 1. In this example, the image pickup device is an NTSC device and operates at a vertical synchronization frequency of 60 Hz and an exposure time t₂ of 1/100 seconds under a non-inverter fluorescent light energized by a power source frequency of 50 Hz. Namely, the exposure time t₂ of the image pickup device is equal to an ON/OFF period of 1/100 seconds of the fluorescent light.

Without regard to exposure timing in lines L₁, L₂, . . . , the exposure time t₂ of the image pickup device is equal to one brightness change period of the fluorescent light. Accordingly, each field or adjacent fields cause no flicker due to a brightness change of the fluorescent light, as shown in FIGS. 5A to 5C.

If the image pickup device is a PAL device and operates at a vertical synchronization frequency of 50 Hz under a non-inverter fluorescent light energized by a power source frequency of 60 Hz, the flicker and lateral stripes mentioned above will occur and will repeat every five fields.

If the vertical synchronization frequency of an image pickup device agrees with the power source frequency of a non-inverter fluorescent light and if an exposure time of the image pickup device is not equal to an integer multiple of the brightness change period of the fluorescent light, each field shows lateral stripes due to the exposure timing deviation. In this case, there is no periodic deviation between adjacent fields, and therefore, the lateral stripes appear at fixed locations in each field.

To suppress flicker, there have been proposed a technique of properly adjusting the gain of an output signal provided by an image pickup device, a technique of controlling the exposure time of an image pickup device, and a technique of detecting whether or not a light such as a fluorescent light that repeats ON/OFF operations is present in the environment of an image pickup device and determining the frequency of the ON/OFF operations.

To detect the environment of an image pickup device and the presence of flicker, a dedicated photosensor is needed, or a photodetector for a remote controller is required. The dedicated photosensor increases the size and cost of an image pickup apparatus. The technique of using the photodetector for a remote controller is not applicable to a system that operates without a remote controller.

There is a technique of employing an image pickup device that includes dedicated photosensors arranged around a regular image pickup area. This technique requires such a special image pickup device, and therefore, is not applicable to an image pickup apparatus employing a standard image pickup device.

There is a technique to detect a photographing environment in a video signal provided by an image pickup device. This technique is disclosed in Japanese Unexamined Patent Application Publications No. 2002-84466 and No. 2005-86423.

The technique of the Publication No. 2002-84466 detects flicker in a video signal provided by an image pickup device and determines whether or not there is a flicker causing environment. If there is, the technique controls the exposure time of the image pickup device, to suppress the flicker. The technique of the Publication No. 2005-86423 temporarily changes an exposure time several times to detect flicker and determine whether or not there is a flicker causing environment. If there is, the technique controls the exposure time of the image pickup device, to suppress the flicker.

The technique of the Publication No. 2002-84466 detects flicker caused by a light according to accumulated signals sampled from video signals for predetermined lines and controls an exposure time to suppress the flicker. This technique is unable to detect flicker in a video signal provided by an image pickup device whose exposure time has once been set not to cause flicker.

If a light source in the environment of an image pickup device is changed from a fluorescent light to a bulb or natural light that causes no flicker, the technique of the Publication No. 2002-84466 is unable to determine whether or not the flicker suppressing control of an exposure time is still needed.

The technique of the Publication No. 2005-86423 must temporarily set a special exposure time for detecting flicker. This technique is also unable to detect an environmental change that occurs after an exposure time is set not to cause flicker.

### SUMMARY OF THE INVENTION

An object of the present invention is to provide an image pickup apparatus employing an x-y addressing image pickup device, capable of detecting flicker even after an exposure time to suppress flicker is set for the image pickup device.

In order to accomplish the object, a first aspect of the present invention provides an image pickup apparatus having a solid image pickup device of x-y addressing type configured to photoelectrically convert incoming light into an image signal, the image pickup device having a regular image pickup area corresponding to an output image signal and a detection area defined along the regular image pickup area; a detector configured to detect a frequency component in an image signal provided by the detection area; an environment determination unit configured to determine, according to the detected frequency component, whether or not there is a flicker causing environment; and an exposure time setter configured to set an exposure time for the image pickup device, if the environment determination unit determines that there is the flicker causing environment, the exposure time setter setting, according to the detected frequency component, an exposure time for the regular image pickup area so as to suppress flicker.

The first aspect of the present invention detects a frequency component in an image signal provided by the detection area, determines if the image pickup apparatus is in a flicker causing environment according to the frequency component, and if it is in the flicker causing environment, sets an exposure time for the regular image pickup area so as to suppress flicker. Even if the regular image pickup area is set to a flicker suppressing exposure time, the first aspect can detect flicker with the use of the detection area.

According to a second aspect of the present invention that is based on the first aspect, the environment determination unit determines whether or not the incoming light contains light from a fluorescent lamp, and if the environment determination unit determines that the incoming light contains light from a fluorescent lamp, the exposure time setter sets an exposure time for the regular image pickup area so as to suppress flicker caused by the fluorescent lamp.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a view showing image pickup areas of a CMOS image pickup device in an image pickup apparatus according to a related art;

FIG. 2 is a timing chart showing an example of exposure time control of the image pickup areas shown in FIG. 1;

FIGS. 3A to 3C are views showing flicker appearing in the image pickup areas of FIG. 1 caused by the control of FIG. 2;

FIG. 4 is a timing chart showing another example of exposure time control of the image pickup areas shown in FIG. 1;

FIGS. 5A to 5C are views showing no flicker appearing in the image pickup areas of FIG. 1 due to the control of FIG. 4;

FIG. 6 is a block diagram showing an image pickup apparatus according to an embodiment of the present invention;

FIG. 7 is a block diagram showing a flicker detector arranged in the image pickup apparatus of FIG. 6;

FIGS. 8A to 8C are views showing examples of image pickup areas defined in a CMOS image pickup device of the image pickup apparatus of FIG. 6;

FIG. 9 is a view showing examples of detection sections set in an environment detection area defined in the CMOS image pickup device of the image pickup apparatus of FIG. 6;

FIG. 10 is a timing chart explaining a technique of the present invention to control exposure times of the image pickup areas of the CMOS image pickup device shown in FIGS. 8A to 8C;

FIGS. 11A to 11C show results of the control technique of FIG. 10 with the image pickup areas of FIG. 8B;

FIGS. 12A to 12C show results of the control technique of FIG. 10 with the image pickup areas of FIG. 8A;

FIGS. 13A to 13C show results of the control technique of FIG. 10 with the image pickup areas of FIG. 8C; and

FIG. 14 is a view showing a final output area, a camera shake compensation area, and an environment detection area defined in a regular image pickup area of a CMOS image pickup device according to an embodiment of the present invention.

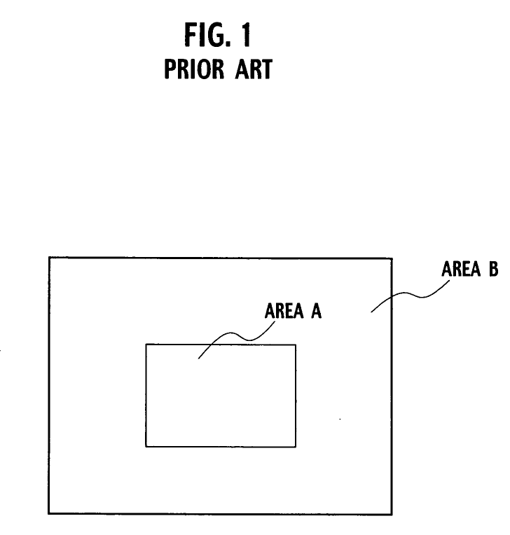

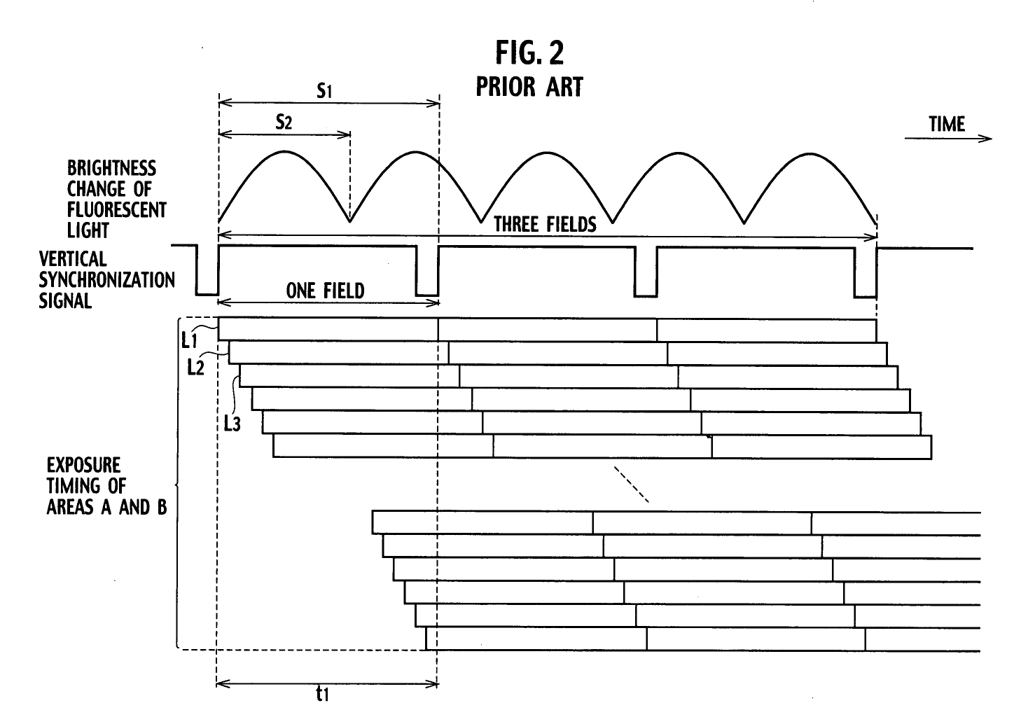

### DETAILED DESCRIPTION OF EMBODIMENTS

An image pickup apparatus according to an embodiment of the present invention will be explained in detail with reference to the drawings.

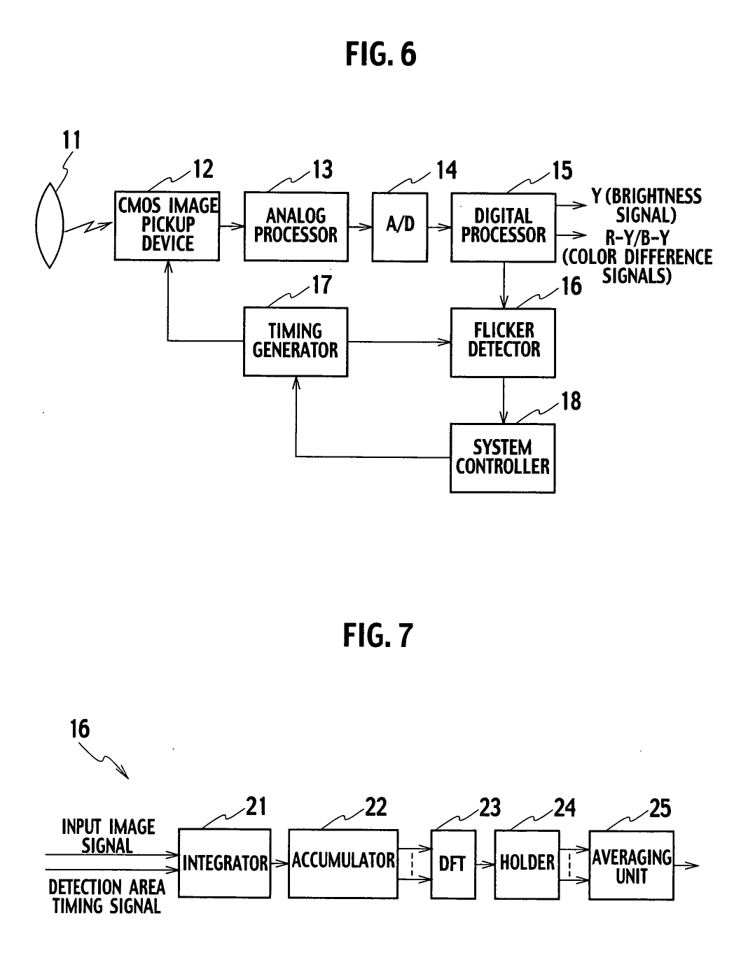

FIG. 6 is a block diagram showing an image pickup apparatus according to an embodiment of the present invention.

In FIG. 6, the image pickup apparatus includes an optical system 11, a CMOS image pickup device 12 to receive image light from the optical system 11 and photoelectrically convert the image light into an analog image signal, an analog processor 13 to carry out a sample hold process, an AGC process, and the like on the analog image signal provided by the CMOS image pickup device 12, an A/D converter 14 to convert the analog image signal provided by the analog processor 13 into a digital image signal, a digital processor 15 to carry out a clamp process, a gain adjustment, a WB adjustment, a gamma correction, and the like on the digital image signal provided by the A/D converter 14, a flicker detector 16 to detect flicker in the digital image signal provided by the digital processor 15, a timing generator 17 to supply timing signals to the CMOS image pickup device 12 and flicker detector 16, and a system controller 18 to control various parts of the image pickup apparatus.

FIG. 7 is a block diagram showing the details of the flicker detector 16.

In FIG. 7, the flicker detector 16 includes an integrator 21 to integrate a digital image signal from the digital processor 15 and calculate an average signal level, an accumulator 22 to accumulate integrated results provided by the integrator 21 for a required number of fields, a DFT (discrete Fourier transform) unit 23 to calculate frequency components of the image signals of the several fields provided by the accumulator 22, a holder 24 to hold the calculated frequency components of the DFT unit 23, and an averaging unit 25 to average and normalize the frequency components provided by the holder 24.

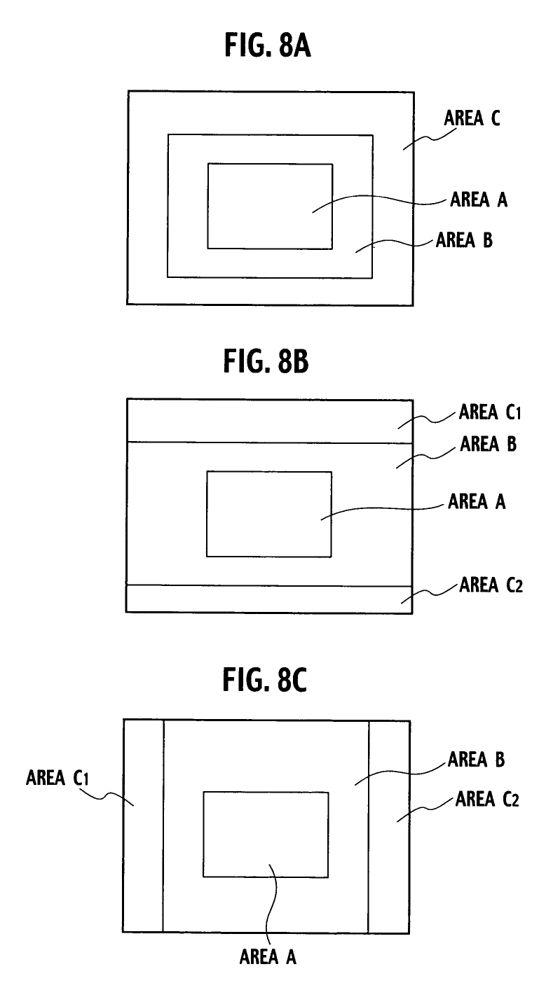

FIGS. 8A to 8C show image pickup areas defined in the CMOS image pickup device 12. In FIG. 8A, the CMOS image pickup device 12 has a regular image pickup area A for outputting an image signal, a camera shake compensation area B defined around the area A, and an environment detection area C defined around the area B. Image pickup elements of the CMOS image pickup device 12 corresponding to the environment detection area C are not special ones but they are those that are part of the camera shake compensation area B and used to detect a photographing environment.

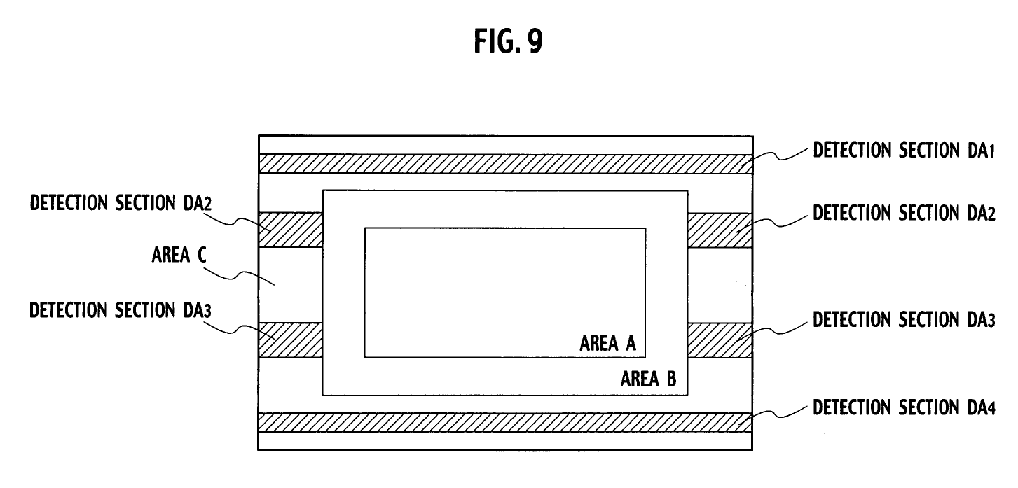

In the environment detection area C, detection sections are set to provide image signals for environment detection. FIG. 9 shows four environment detection sections DA₁ to DA₄ defined in the environment detection area C shown in FIG. 8A.

The CMOS image pickup device 12 may have only top and bottom environment detection areas C₁ and C₂ as shown in FIG. 8B, or only left and right environment detection areas C₁ and C₂ as shown in FIG. 8C.

Operation of the image pickup apparatus of FIG. 6 and a technique of the present invention of preventing flicker will be explained.

A CCD image pickup device employs the same charge start time and the same exposure time in each field. On the other hand, an x-y addressing image pickup device such as a CMOS image pickup device changes a charge start time pixel by pixel. Namely, the CMOS image pickup device can change an exposure time in a given field by changing the reset timing of each pixel.

Accordingly, the timing generator 17 of FIG. 6 controls an exposure time of the regular image pickup area A and camera shake compensation area B so as to suppress flicker like the related art and sets a different exposure time for the environment detection sections C₁ and C₂. For the sake of simplicity, the explanation that follows employs the arrangement of FIG. 8B having the top and bottom environment detection areas C₁ and C₂.

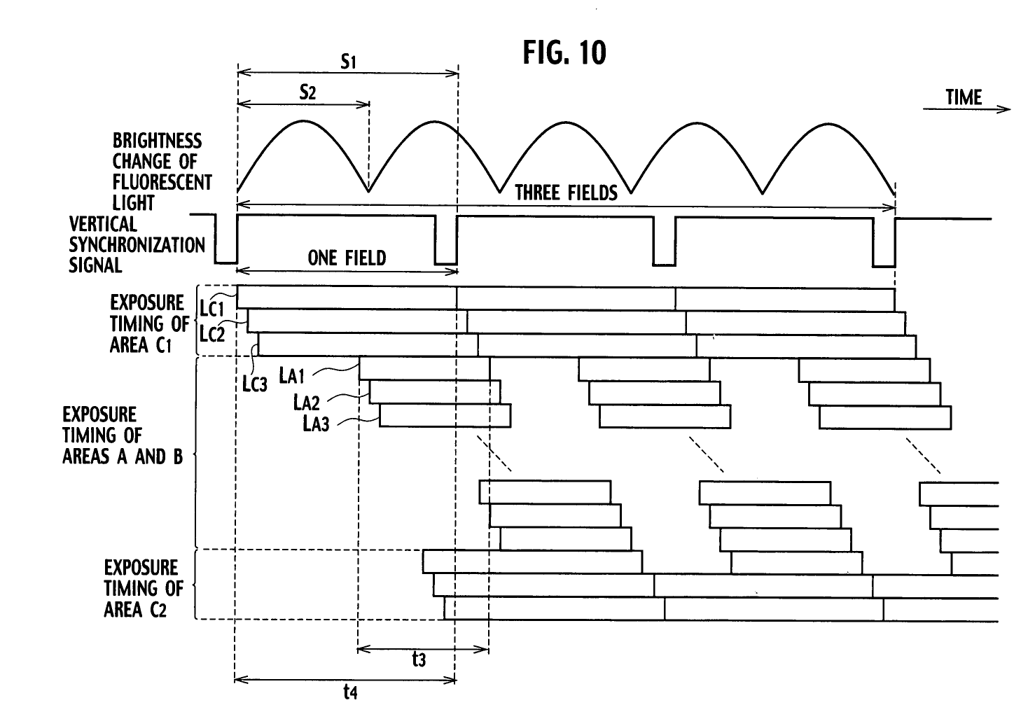

FIG. 10 is a timing chart showing an example of operation of the image pickup apparatus of FIG. 6. In this example, the CMOS image pickup device 12 is an NTSC device and operates at a vertical synchronization frequency of 60 Hz under a non-inverter fluorescent light energized by a power source frequency of 50 Hz. In the image pickup areas A and B, an exposure time t₃ for lines L_{A1}, L_{A2}, . . . is 1/100 seconds equal to a brightness change period S₂ of the fluorescent light. In the environment detection areas C₁ and C₂, an exposure time t₄ for lines L_{C1}, L_{C2}, . . . is 1/60 seconds equal to a vertical synchronization signal period S₁.

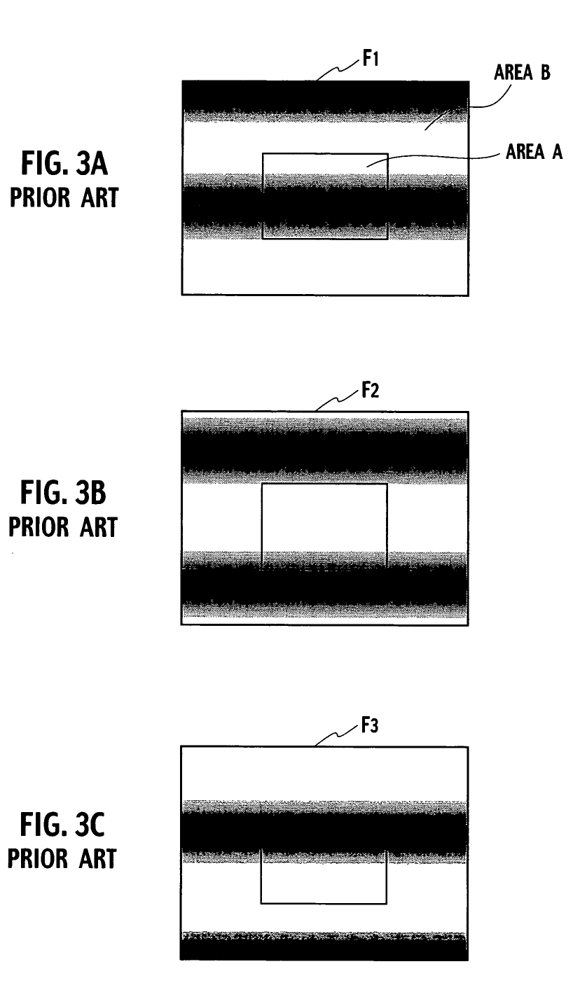

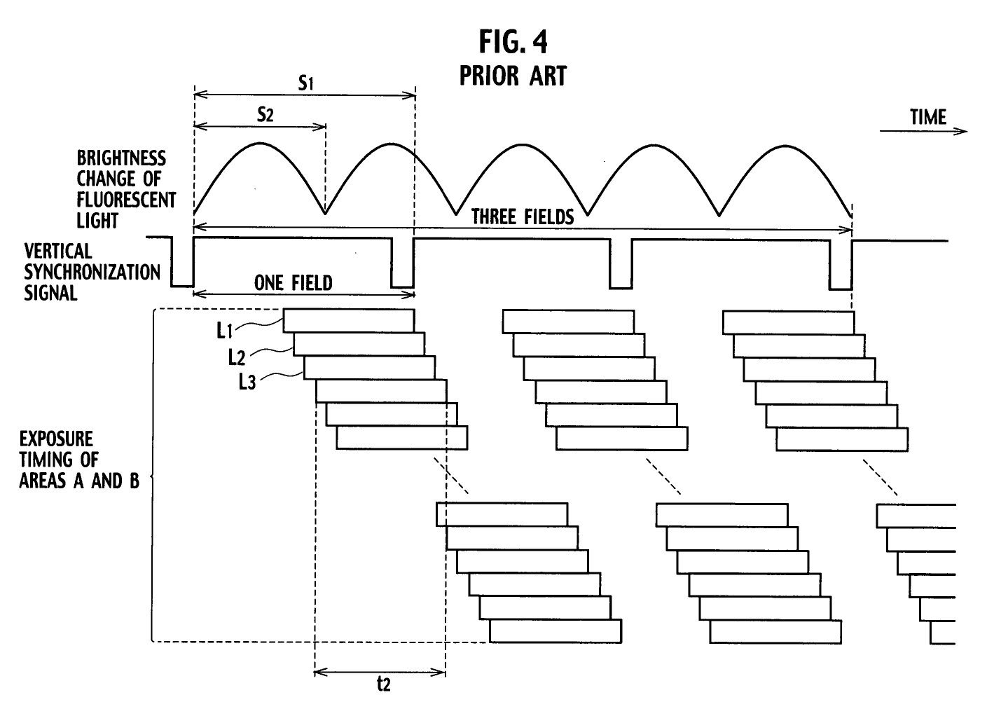

In the environment detection areas C₁ and C₂ of FIG. 8B, lateral stripes appears in every field and flicker occurs at intervals of three fields, as shown in FIGS. 3A to 3C. The present invention detects a flicker component in image signals provided by the environment detection areas C₁ and C₂ and controls the exposure time of the image pickup areas A and B accordingly.

Detecting a flicker component and controlling an exposure time in the image pickup apparatus according to the present invention will be explained.

The CMOS image pickup device 12 receives image light from the optical system 11, photoelectrically converts the image light into an analog image signal, and supplies the analog image signal to the analog processor 13. The analog processor 13 carries out a sample hold process, an AGC process, and the like on the analog image signal provided by the CMOS image pickup device 12 and supplies the processed analog image signal to the A/D converter 14. The A/D converter 14 converts the analog image signal provided by the analog processor 13 into a digital image signal.

The digital processor 15 carries out a clamp process, a gain adjustment, a WB adjustment, a gamma correction, and the like on the digital image signal provided by the A/D converter 14 and outputs a brightness signal and color difference signals.

The flicker detector 16 receives from the digital processor 15 the brightness signal and RGB signals that are appropriate for detecting a flicker component. The flicker detector 16 also receives from the timing generator 17 a timing signal for the detection sections defined in the environment detection areas C₁ and C₂. Then, the flicker detector 16 detects a flicker component in the image signals from the detection sections.

Operation of the flicker detector 16 will be explained. The flicker detector 16 detects frequency components in the image signals provided by the digital processor 15 according to the detection section specifying timing signal provided by the timing generator 17. Each detection section in the environment detection areas C₁ and C₂ is located so that the section substantially involves a uniform flicker level. A plurality of the detection sections are defined in the environment detection areas C₁ and C₂, to improve detection performance.

The integrator 21 integrates image signals from the detection sections and calculates an average signal level of the detection sections. The accumulator 22 accumulates integrated results provided by the integrator 21 for a required number of fields and supplies the accumulated data to the DFT (discrete Fourier transform) unit 23.

The DFT unit 23 uses the vertical synchronization frequency as a sampling frequency to calculate frequency components of the image signals for several fields of each detection section provided by the accumulator 22. The holder 24 holds a calculation result of each detection section provided by the DFT unit 23.

The averaging unit 25 averages and normalizes the frequency components provided by the holder 24 and provides a detection result so that the system controller 18 may easily determine flicker and frequency components.

The flicker detector 16 supplies the detection result to the system controller 18. Based on the detection result from the flicker detector 16, the system controller 18 determines whether or not the environment of the image pickup apparatus needs exposure time control to suppress flicker. If the exposure time control is needed, the system controller 18 instructs the timing generator 17 to control the exposure time of the image pickup areas A and B. According to the instruction, the timing generator 17 controls the exposure time of the areas A and B of the CMOS image pickup device 12. No change is made in the exposure time of the environment detection areas C₁ and C₂, so that flicker is continuously detectable in the environment detection areas C₁ and C₂.

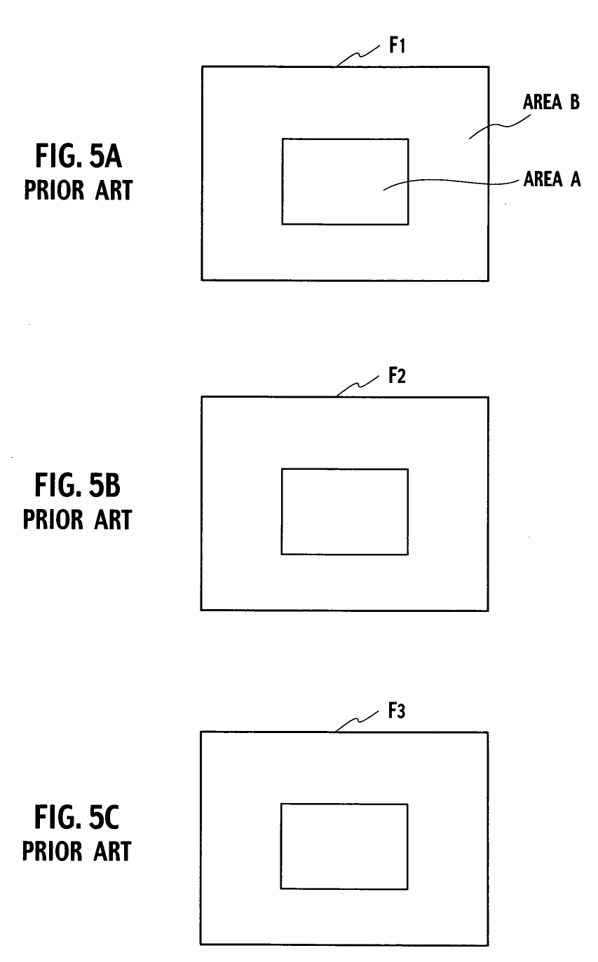

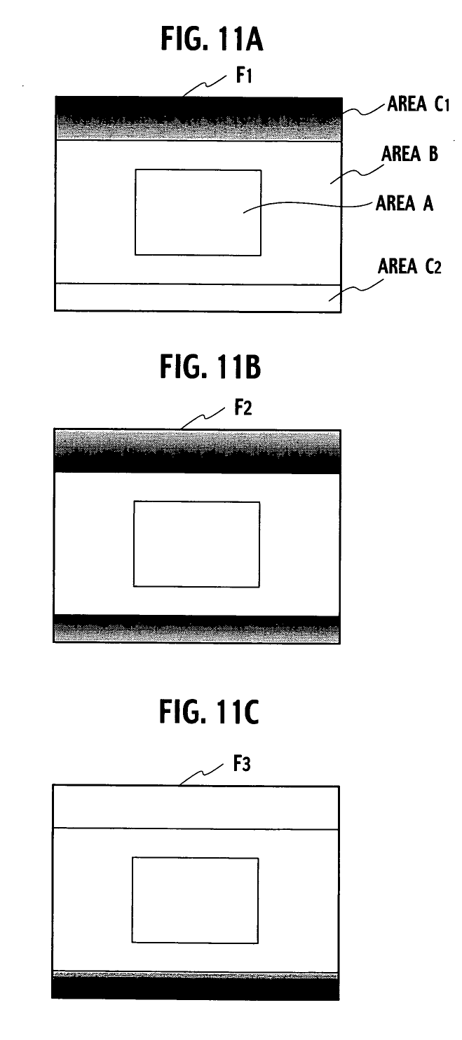

When the image pickup apparatus is used at a vertical synchronization frequency of 60 Hz under a non-inverter fluorescent light energized by a power source frequency of 50 Hz as shown in FIG. 10, the exposure time t₃ of the image pickup areas A and B is set to be equal to a brightness change period of the fluorescent light, i.e., 1/100 seconds, so that the areas A and B may provide image signals causing no flicker as shown in FIGS. 5A to 5C. At this time, if an object to be photographed with the image pickup device is uniform, image signals provided by the areas A, B, C₁, and C₂ of the image pickup device 12 will be as shown in FIGS. 11A to 11C.

As explained above, the exposure time of the environment detection areas C₁ and C₂ is not changed, and therefore, the areas C₁ and C₂ provide flicker containing image signals as shown in FIGS. 11A to 11C, even when the exposure time of the image pickup areas A and B is set to suppress flicker. As a result, the image signals from the areas C₁ and C₂ can be used to detect flicker and determine whether or not there is a change in the environment of the image pickup apparatus.

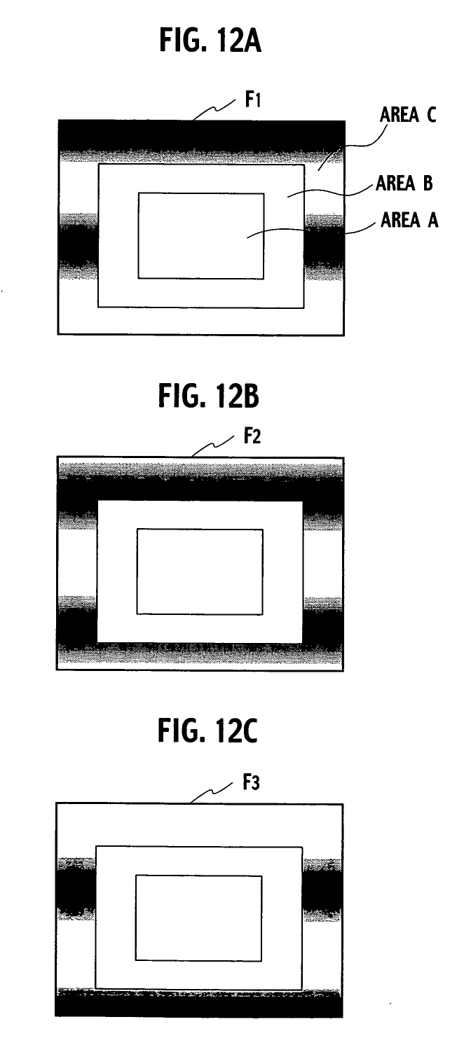

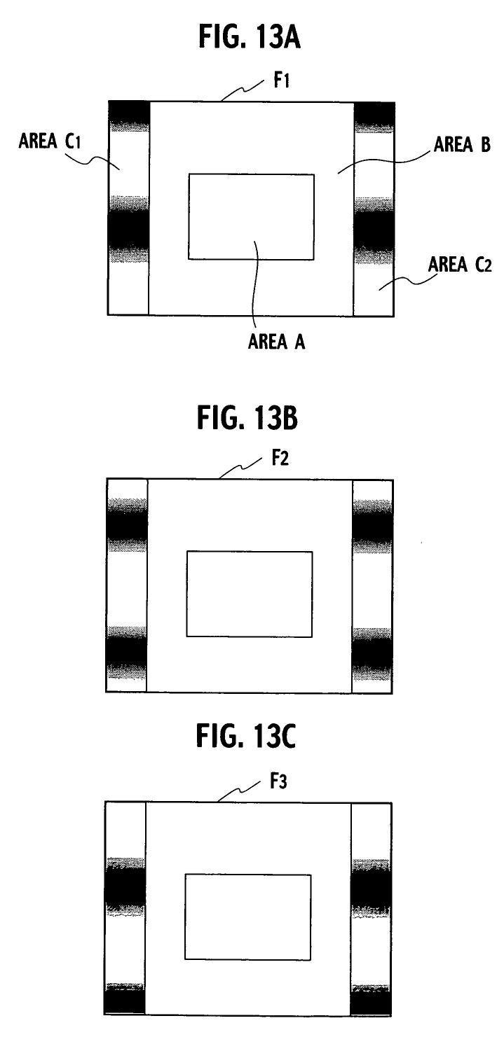

When the image pickup device 12 is divided into the areas A, B, C₁, and C₂ shown in FIG. 8A, the image pickup device 12 provides image signals shown in FIGS. 12A to 12C. And when the device 12 is divided as shown in FIG. 8C, it provides image signals shown in FIGS. 13A to 13C. In each case, the environment detection areas C, C₁, and C₂ provide image signals that allows detection of flicker.

In this way, the embodiment mentioned above prepares the environment detection areas C₁ and C₂ around the regular image pickup area A in the image pickup device 12, detects frequency components in image signals provided by the areas C₁ and C₂, and according to the frequency components, determines whether or not there is a flicker causing environment. If there is a flicker causing environment, the embodiment sets an exposure time for the regular image pickup area A to suppress flicker and maintains the exposure time of the areas C₁ and C₂ so that the areas C₁ and C₂ are continuously useful to detect flicker. Namely, even if the regular image pickup area A is set to a flicker suppressing exposure time, the areas C₁ and C₂ can be used to detect flicker and determine whether or not there is a change in the environment of the image pickup apparatus.

According to the embodiment, the environment detection areas C₁ and C₂ are defined around the camera shake compensation area B in the image pickup device 12. For a system employing a technique of optically compensating a camera shake, the camera shake compensation area B shown in FIGS. 8A to 8C may be used as the environment detection area C.

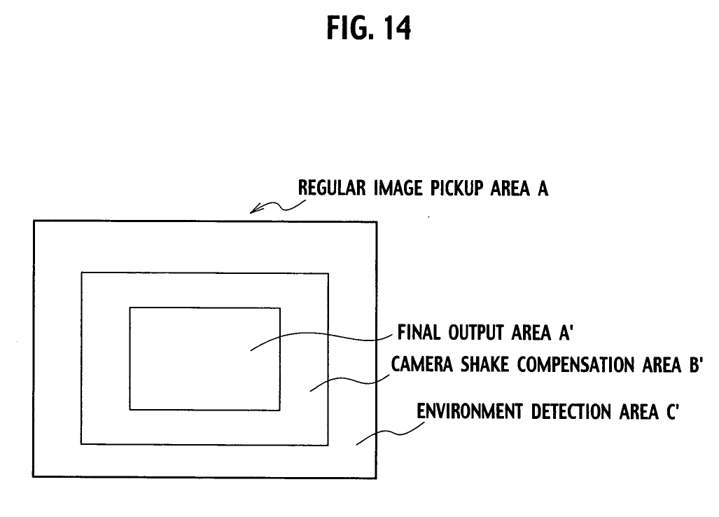

There is an image pickup device having no camera shake compensation area around a regular image pickup area. This sort of image pickup device may conduct a camera shake compensation by electrically enlarging a part of the regular image pickup area. In this case, a final output area A′, a camera shake compensation area B′, and an environment detection area C′ may be defined in a regular image pickup area A, as shown in FIG. 14.

According to another embodiment of the present invention, a plurality of environment detection areas C may have different exposure times. For example, in FIG. 8B, the top environment detection area C₁ may have an exposure time of 1/60 seconds and the bottom environment detection area C₂ an exposure time of 1/1000 seconds. This configuration improves flicker detecting performance.

Still another embodiment of the present invention may change the exposure time of an environment detection area C and control the output level of an image signal provided by the environment detection area C, to optimally control the exposure time of a regular image pickup area A.

It should be understood that many modifications and adaptations of the invention will become apparent to those skilled in the art and it is intended to encompass such obvious modifications and changes in the scope of the claims appended hereto.

What is claimed is:

1. An image pickup apparatus comprising:
a solid image pickup device of x-y addressing type configured to photoelectrically convert incoming light into an image signal, the image pickup device having a regular image pickup area corresponding to an output image signal and a detection area defined along the regular image pickup area;
a detector configured to detect a frequency component in an image signal provided by the detection area;
an environment determination unit configured to determine, according to the detected frequency component, whether or not there is a flicker causing environment; and
an exposure time setter configured to set an exposure time for the image pickup device, if the environment determination unit determines that there is the flicker causing environment, the exposure time setter setting, according to the detected frequency component, an exposure time for the regular image pickup area so as to suppress flicker.

2. The image pickup apparatus of claim 1, wherein:
the environment determination unit determines whether or not the incoming light contains light from a fluorescent lamp; and
if the environment determination unit determines that the incoming light contains light from a fluorescent lamp, the exposure time setter sets an exposure time for the regular image pickup area so as to suppress flicker caused by the fluorescent lamp.
